(19) United States
(12) Patent Application Publication
(10) Pub. No.: US 2015/0251375 A1
(43) Pub. Date: Sep. 10, 2015

(54) FLOOR MAT

(71) Applicant: Chieh-Jen LIN, New Taipei City (TW)

(72) Inventor: Chieh-Jen LIN, New Taipei City (TW)

(21) Appl. No.: 14/197,419

(22) Filed: Mar. 5, 2014

(51) Int. Cl. B32B 3/26; B32B 25/04; B32B 25/16; B32B 5/02

(52) U.S. Cl. CPC B32B 3/26; B32B 5/02; B32B 25/045; B32B 25/16; B32B 2250/03; B32B 2305/022; B32B 2471/04

(57) ABSTRACT

A floor mat has a rubber layer, a foam layer and a fabric layer. The foam layer is mounted on the rubber layer. The fabric layer is mounted on the foam layer. The foam layer effectively increases a thickness of the floor mat, and thus provides enhanced relief effect. A material of the foam layer costs much lower than a material of the rubber layer, such that the cost of the floor mat is reduced.

### BACKGROUND OF THE INVENTION

1. Field of the Invention

The present invention relates to a floor mat, especially to a floor mat that has enlarged thickness and reduced cost.

2. Description of the Prior Arts

A floor mat is a common household item. One kind of floor mat can absorb water, and is placed on the floor in front of an entrance to the bathroom. Another kind of floor mat is resilient, and is used in the kitchen or other household spaces to relieve the pressure of the feet, the ankles and knees when the user stands on it for a long time.

With reference to FIG. 7, a conventional floor mat comprises a rubber layer 91 and a fabric layer 92. The fabric layer 92 is mounted on the rubber layer 91, and then the fabric layer 92 and the rubber layer 91 together are cut into a required size. The cut edge of the fabric layer 92 and the rubber layer 91 are left exposed or are further bound.

However, the conventional floor mat has the following shortcomings The thickness of the conventional floor mat is too thin, such that the relief effect is insufficient. The manufacturer can increase the thickness of the rubber layer 91 to make the conventional floor mat thicker, but the thickened rubber layer 91 increases manufacture cost. Besides, the user may stumble over the thickened floor mat. Having the edge of the conventional floor mat bound may resolve the issue of stumbling, as binding makes the edge inclined with a slope. Nevertheless, the binding step is also time-consuming and costly.

To overcome the shortcomings, the present invention provides a floor mat to mitigate or obviate the aforementioned problems.

### SUMMARY OF THE INVENTION

The main objective of the present invention is to provide a floor mat that has an enlarged thickness with reduced cost.

The floor mat has a rubber layer, a foam layer and a fabric layer. The foam layer is mounted on the rubber layer. The fabric layer is mounted on the foam layer. The foam layer effectively increases a thickness of the floor mat, and thus provides enhanced relief effect. A material of the foam layer costs much lower than a material of the rubber layer, such that the cost of the floor mat is reduced.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a floor mat in accordance with the present invention;

FIG. 2 is a side view in partial section of the floor mat in FIG. 1;

FIG. 3 is a bottom view of the floor mat in FIG. 1;

FIG. 4 is a partially enlarged perspective view of the floor mat in FIG. 1;

FIG. 5 is a top view of the floor mat in FIG. 1;

FIG. 6 is a top view of another embodiment of the floor mat in FIG. 1; and

FIG. 7 is a perspective view in partial section of a conventional floor mat in accordance with the prior art.

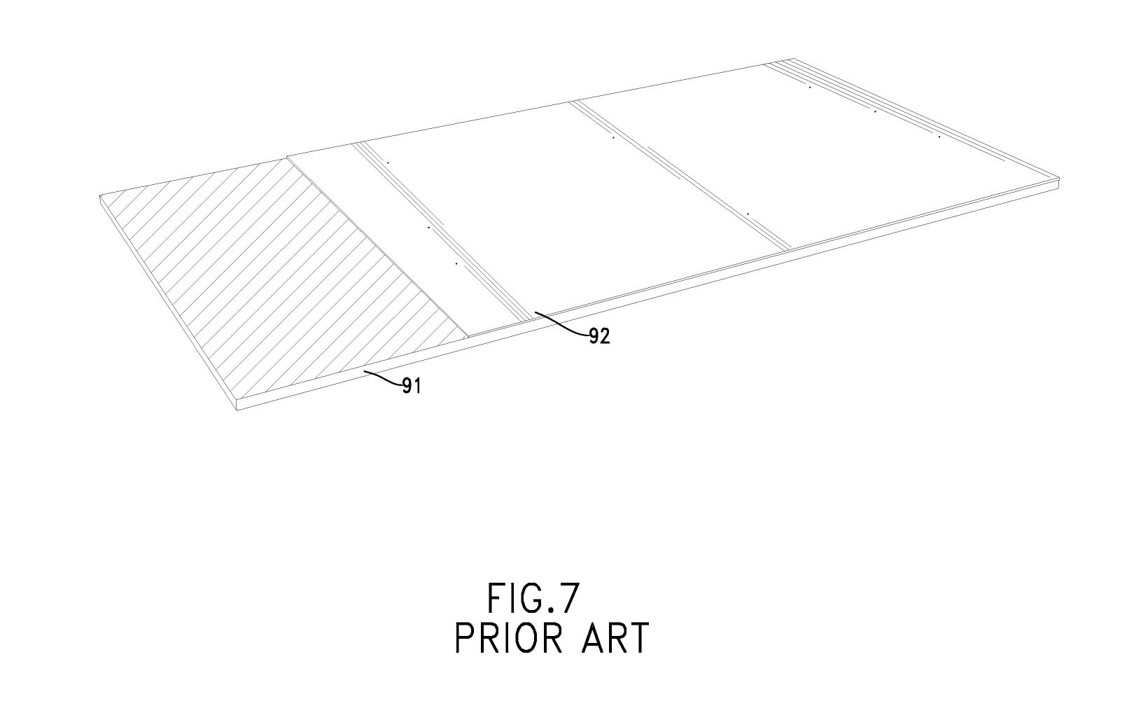

### DETAILED DESCRIPTION OF THE PREFERRED EMBODIMENTS

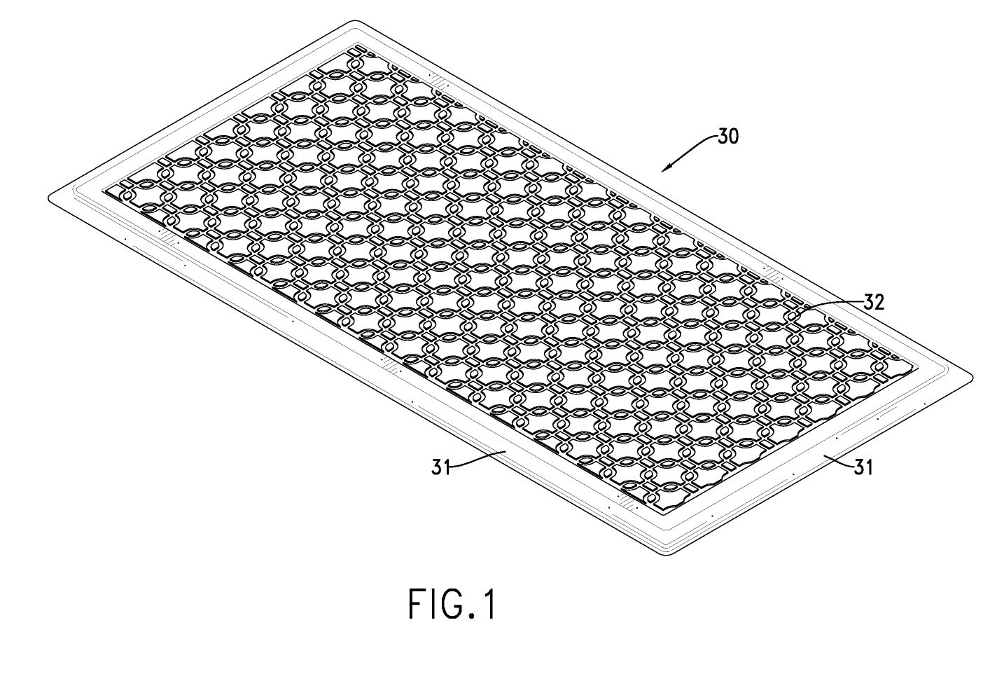

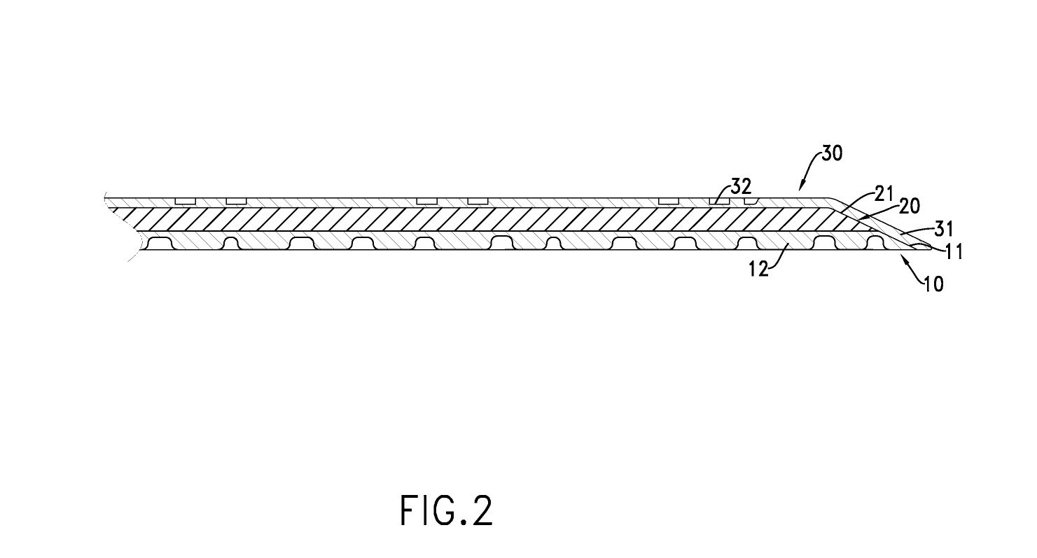

With reference to FIGS. 1 and 2, a floor mat in accordance with the present invention comprises a rubber layer 10, a foam layer 20 and a fabric layer 30.

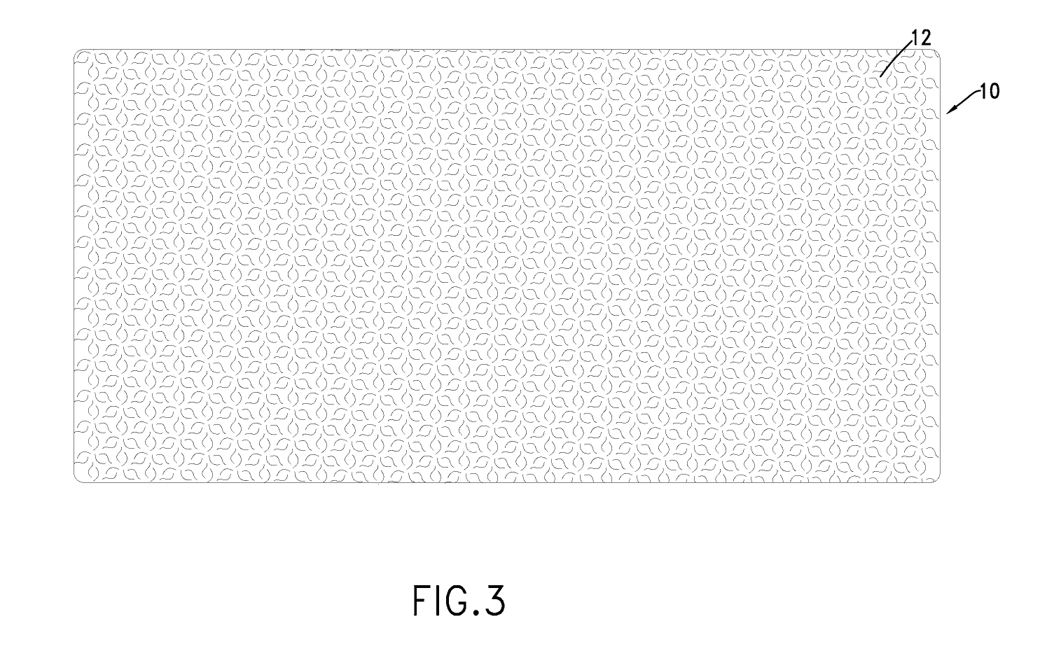

With reference to FIGS. 2 and 3, the rubber layer 10 is rectangular and has four rubber slopes 11 and multiple skid-proof protrusions 12. The rubber slopes 11 are respectively formed in four sides of the rubber layer 10, and are inclined downward from inside toward outside of the rubber layer 10. The skid-proof protrusions 12 are formed on a bottom of the rubber layer 10 at equal intervals. In a preferred embodiment, the rubber layer 10 is made of, but not limited to, nitrile butadiene rubber (NBR).

With reference to FIG. 2, the foam layer 20 is rectangular, is mounted on the rubber layer 10 and has four foam slopes 21. The foam slopes 21 are respectively formed in four sides of the foam layer 20, and are inclined downward from inside toward outside of the foam layer 20. In a preferred embodiment, the foam layer 20 is made of, but not limited to, ethylene vinyl acetate (EVA).

With reference to FIGS. 1 and 2, the fabric layer 30 is rectangular, is mounted on the foam layer 20, and has four fabric slopes 31. The fabric slopes 31 are respectively formed in four sides of the fabric layer 30, and are respectively flush with the foam slopes 21 of the foam layer 20 and the rubber slopes 11 of the rubber layer 10. The rubber layer 10, the foam layer 20 and the fabric layer 30 are compression molded to form the rubber slopes 11, the foam slopes 21 and the fabric slopes 31.

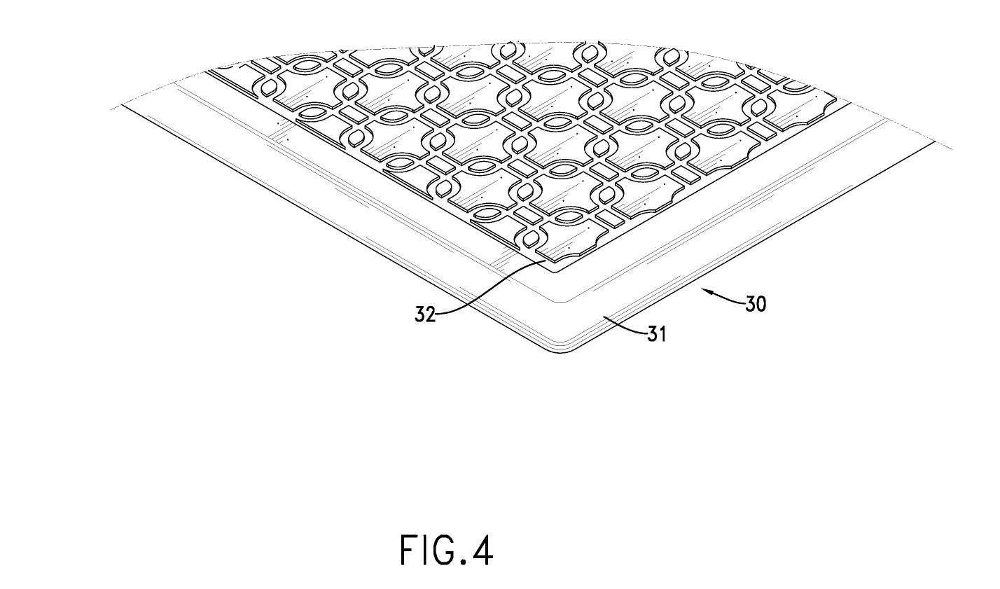

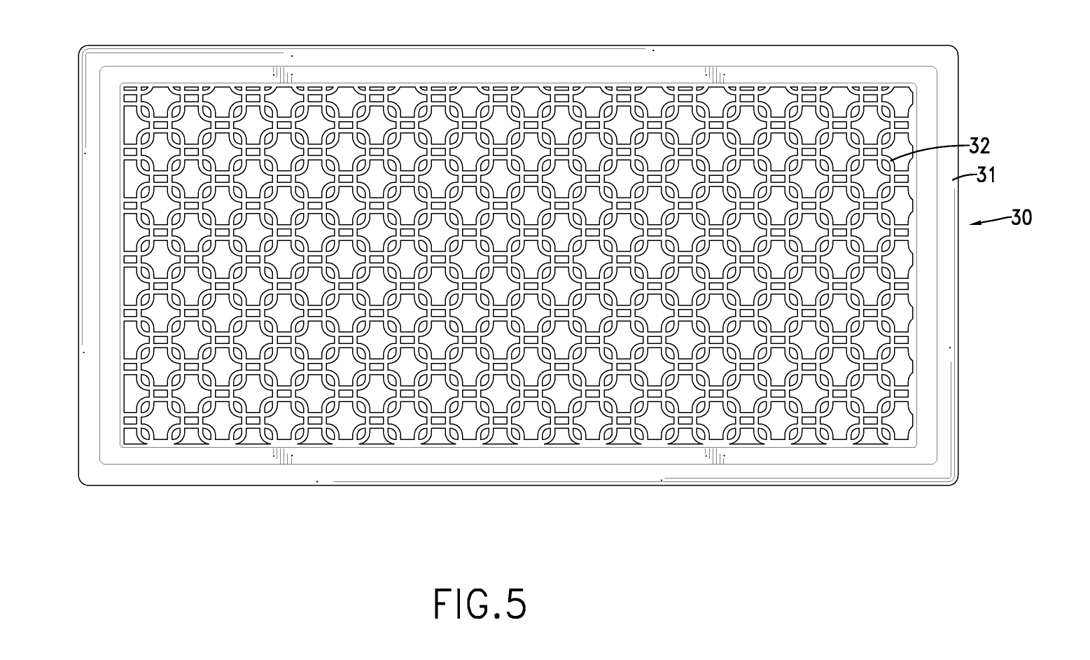

With reference to FIGS. 1, 4 and 5, the fabric layer 30 has multiple grooves 32 formed in a top of the fabric layer 30 at regular intervals. Each of the grooves 32 is a square loop, and two corners of any two adjacent grooves 32 intersect each other. In a preferred embodiment, the fabric layer 30 is made of, but not limited to, ramie cotton, polyurethane (PU), polyamide (Nylon) or polyester.

With reference to FIG. 2, the foam layer 20 is thicker than each of the rubber layer 10 and the fabric layer 30. A material of the foam layer 20 costs much lower than a material of the rubber layer 10, such that the floor mat can effectively increase its thickness to provide enhanced relief effect with reduced cost by using the foam layer 20 to compose the most thickness of the floor mat as described.

Although the floor mat of the present invention is thicker than the conventional floor mat, the rubber slopes 11, the foam slopes 21 and the fabric slopes 31 can prevent the user from stumbling over the floor mat. Besides, the rubber slopes 11, the foam slopes 21 and the fabric slopes 31 are formed by compression molding, which is relatively simplified in process and is not as costly as the conventional binding step.

For use, the floor mat as described can be disposed in a kitchen. The user can stand on the floor mat as described when cooking, washing dishes and so on. The resilience of the thick foam layer 20 can effectively absorb the resisting force from the user when the user moves, thereby relieving the pressure of the feet, the ankles and knees. The thick foam layer 20 also can be resiliently deformed to fit the contour of the feet, thereby making the feet more comfortable when the user stands on the floor mat for a long time.

In addition, the grooves 32 on the fabric layer 30 prevent the user from skidding on the floor mat, and the skid-proof protrusions 12 of the rubber layer 10 prevent the floor mat from skidding on the floor.

Furthermore, the floor mat also can be disposed in front of an entrance to the bathroom to absorb water.

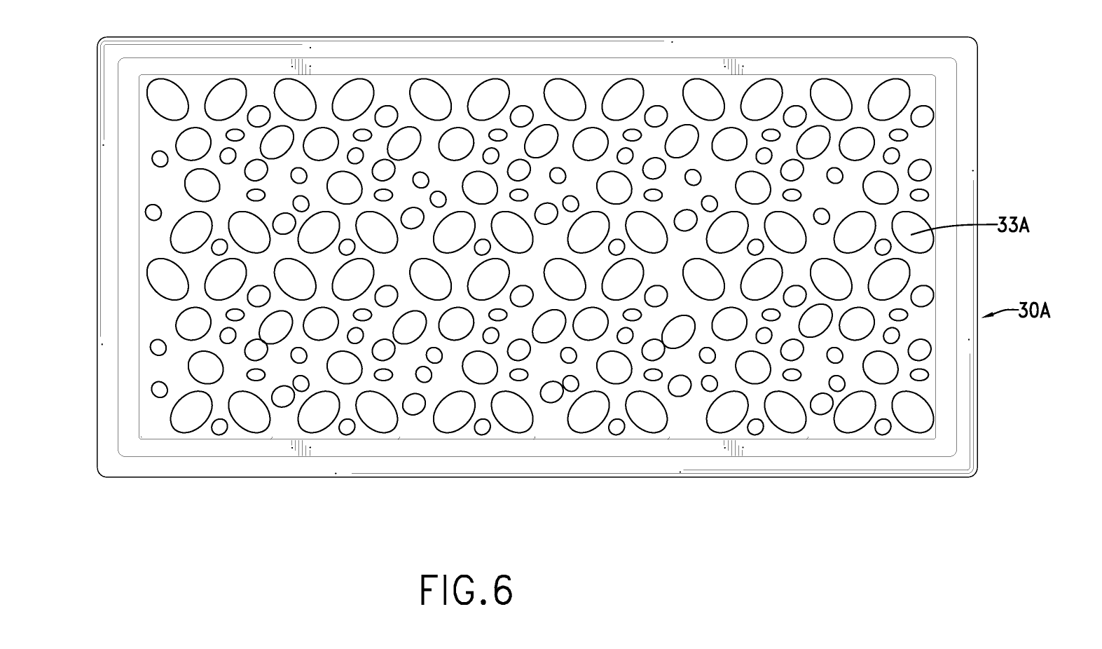

With reference to FIG. 6, in another embodiment, the top of the fabric layer 30A may be altered in forms, such as having multiple contact protrusions 33A formed on the top of the fabric layer 30A, thereby providing a massage-like effect.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A floor mat comprising:
a rubber layer;
a foam layer mounted on the rubber layer; and
a fabric layer mounted on the foam layer.

2. The floor mat as claimed in claim 1, wherein the fabric layer has multiple grooves formed in a top of the fabric layer.

3. The floor mat as claimed in claim 2, wherein the grooves intersect each other at regular intervals.

4. The floor mat as claimed in claim 3, wherein each of the grooves is a square loop, and two corners of any two adjacent grooves intersect each other.

5. The floor mat as claimed in claim 1, wherein the fabric layer has multiple contact protrusions formed on a top of the fabric layer.

6. The floor mat as claimed in claim 1, wherein the rubber layer has multiple skid-proof protrusions formed on a bottom of the rubber layer.

7. The floor mat as claimed in claim 6, wherein the skid-proof protrusions are arranged at regular intervals.

8. The floor mat as claimed in claim 1, wherein the fabric layer covers peripheries of the rubber layer and the foam layer.

9. The floor mat as claimed in claim 8, wherein
the rubber layer, the foam layer and the fabric layer are rectangular;
the rubber layer has
four rubber slopes respectively formed in four sides of the rubber layer, and being inclined downward from inside toward outside of the rubber layer;
the foam layer has
four foam slopes respectively formed in four sides of the foam layer, and being inclined downward from inside toward outside of the foam layer; and
the fabric layer has
four fabric slopes respectively formed in four sides of the fabric layer, and respectively flush with the foam slopes of the foam layer and the rubber slopes of the rubber layer.

10. The floor mat as claimed in claim 9, wherein the rubber layer, the foam layer and the fabric layer are compression molded to form the rubber slopes, the foam slopes and the fabric slopes.

11. The floor mat as claimed in claim 1, wherein the foam layer is thicker than each of the rubber layer and the fabric layer

12. The floor mat as claimed in claim 1, wherein the fabric layer is made of ramie cotton.

13. The floor mat as claimed in claim 1, wherein the fabric layer is made of polyurethane.

14. The floor mat as claimed in claim 1, wherein the fabric layer is made of polyamide.

15. The floor mat as claimed in claim 1, wherein the fabric layer is made of polyester.

16. The floor mat as claimed in claim 1, wherein the foam layer is made of ethylene vinyl acetate.

17. The floor mat as claimed in claim 1, wherein the rubber layer is made of nitrile butadiene rubber.
